(19) United States
(12) Patent Application Publication
(10) Pub. No.: US 2010/0007723 A1
(43) Pub. Date: Jan. 14, 2010

(54) IMAGE DISPLAY DEVICE, IMAGE DISPLAY METHOD, AND IMAGE DISPLAY PROGRAM

(75) Inventor: Masashi YASUI, Azumino (JP)

Correspondence Address: HARNESS, DICKEY & PIERCE, P.L.C., P.O. BOX 828, BLOOMFIELD HILLS, MI, 48303, US

(73) Assignee: EPSON IMAGING DEVICES CORPORATION, Azumino-shi (JP)

(21) Appl. No.: 12/496,178

(22) Filed: Jul. 1, 2009

(30) Foreign Application Priority Data
Jul. 11, 2008 (JP) 2008-181840

(51) Int. Cl. H04N 13/04; G09G 3/36

(52) U.S. Cl. 348/59; 345/87; 345/88; 348/54; 348/E13.075

(57) ABSTRACT

An image display device includes display regions, each having sub-pixels arranged therein, a pixel groups, each including a pixels, each pixel being composed of the sub-pixels included in the unit display regions adjacent to each other, a separating element which separates light of the image into light beams directing in different directions in the unit of one pixel group, an image signal supply unit which supplies an identical image signal or different image signals to the pixel groups, respectively, and a selection unit which selects a number of pixel groups or a number of pixels included in the pixel group.

### BACKGROUND

1. Technical Field

The present invention relates to an image display device, an image display method, and an image display program suitable for the display of various kinds of information.

2. Related Art

As an example of an image display device, there is a two-picture display device presenting different images to viewers positioned at different positions, respectively, or a three-dimensional image display device displaying a three-dimensional image. As such image display devices, for example, Japanese Patent No. 3503925 discloses a parallax barrier type image display device using a parallax barrier and JP-A-2005-78078 discloses a lenticular lens type image display device using a lenticular lens.

These image display devices are typically mounted in car navigation systems. In such a case, the image display devices serve as two-picture display devices. That is, a navigation image is visible if the image display device is viewed from the driver's seat but an image from a digital versatile disc (DVD) or a television set is visible if it is viewed from the passenger's seat. However, the image display device has a problem in that a viewer seated behind the driver can only see the navigation image and a viewer seated in the center of the back seats may see a mixture of the image of the car navigation system and the image of the DVD or the television set.

In order to solve such a problem in the above image display devices, the viewing angles of the respective display images displayed on the image display device need to be able to be changed. The technique disclosed in Japanese patent number 3503925 changes the viewing angles of respective images by controlling the movement of a parallax barrier. However, such a method is disadvantageous in that there is a possibility that normal display can not be performed when the parallax barrier is displaced. The technique disclosed in JP-A-2005-78078 uses two lenticular lenses to change viewing angles by changing the distance between the lenses. However, this method also has a problem in that it is difficult to differently set left and right side viewing angles, although it is possible to expand and narrow the viewing angles.

### SUMMARY

An advantage of some aspects of the invention is to provide an image display device capable of changing viewing angles of display images with high precision in image display, thus allowing a plurality of viewers to see different two-dimensional or three-dimensional images at the same time.

According to an aspect of the invention, there is provided an image display device displaying a plurality of images visible in different directions, including: a plurality of unit display regions, each having a plurality of sub-pixels arranged therein; a plurality of pixel groups, each including a plurality of pixels, each pixel being composed of the sub-pixels included in the unit display regions adjacent to each other; a separating element which separates light of the image into light beams directed in different directions in the unit of one pixel group; an image signal supply unit which supplies an identical image signal or different image signals to the plurality of pixel groups, respectively; and a selection unit which selects a number of pixel groups or a number of pixels included in the pixel group.

The image display device is the device with a plurality of unit display regions, each being provided with a plurality of sub-pixels arranged therein, in which a plurality of sub-pixels is arranged in the plurality of unit display regions adjacent to each other and light from the plurality of sub-pixels is separated into light beams directed in different directions so that a plurality of images displayed to the adjacent plural unit display regions is visible in different directions, respectively, in which the plurality of sub-pixels belongs to one group or a plurality of groups. The group is an aggregation of a plurality of pixels displaying the same image signal (image data). The image display device includes an image signal supply unit and a selection unit. These are realized by a control portion having a central processing unit (CPU). The image signal supply unit supplies an identical signal to pixels belonging to the same group but different image signals to pixels belonging to different groups. The selection unit selects the number of groups or the number of pixels included in each of the groups. Here, the number of groups corresponds to the number of view points. For example, in the case in which three groups are selected by the selection unit, different image signals are supplied to the groups, respectively. Accordingly, different images can be seen from three different view points. The number of groups can be changed by the user's selection through the selection unit. Accordingly, if a user selects the number of view points according to the number of viewers, the viewers can see different images, respectively.

With such a structure, it is possible to change viewing angles of display images with high precision without modifying the structure of the image display device, and also the image display device can simultaneously display different two-dimensional images or three-dimensional images to the plurality of viewers, respectively. Each of the plurality of pixels is composed of a plurality of sub-pixels whose colors are different from each other, for example, sub-pixels of RGB colors.

The image display device includes a light separating element which separates light from the plurality of sub-pixels into light beams directing in different directions.

In the image display device, it is preferable that the selection unit can differently set the numbers of pixels included in the groups, respectively. With such a setting it is possible to differently set the viewing angles of the display images, respectively.

In the image display device, the selection unit alternately supplies a left eye image signal and a right eye image signal of the image signals to the plurality of sub-pixels group by group. With such an operation, it is possible to display a three-dimensional image.

In the image display device, it is preferable that, of the unit display regions, the unit display regions adjacent to each other in a perpendicular direction, which is a direction perpendicular to an arrangement direction of the plurality of sub-pixels, are set such that they are misaligned with each other in the arrangement direction of the sub-pixels. With such placement, it is possible to suppress deterioration feeling of resolution in the arrangement direction of the sub-pixels.

In the image display device, it is preferable that the light separating element is a parallax barrier provided with a plurality of slits, in which the slits are formed in the parallax barrier such that they diagonally extend with respect to the perpendicular direction of the arrangement direction of the sub-pixels by the amount of the misalignment of the unit display regions.

In the image display device, the light separating element is a lenticular lens with a plurality of lens patterns, in which the plurality of lens patterns is formed in the lenticular lens such that they diagonally extend with respect to the perpendicular direction of the arrangement direction of the sub-pixels by the amount of the misalignment of the unit display regions.

According to another aspect of the invention, there is provided an electronic apparatus having the above-mentioned liquid crystal device as a display portion.

According to a still another aspect of the invention, there is provided an image display method of displaying a plurality of images to a plurality of unit display regions adjacent to each other such that the plurality of images are visible in different directions by separating light from a plurality of pixels into light beams directing in different directions when there are unit display regions, each having a plurality of sub-pixels arranged therein, and the plurality of pixels is arranged in the adjacent unit display regions, including the steps of: supplying an identical image signal to the pixels belonging to one pixel group or different image signals to the pixels belonging to different pixel groups, respectively while making the plurality of pixels belong to one or a plurality of pixel groups; and selecting the number of pixel groups or the number of pixels included in each pixel group. According to the method, it is possible to change viewing angles of display images with high precision without modifying the structure of the image display device.

According to a still another aspect of the invention, there is provided an image display program executed in a control portion which controls an image display device in which there are unit display regions, each having a plurality of sub-pixels arranged therein, a plurality of pixels is arranged in plural unit display regions adjacent to each other, and a plurality of images displayed at the plurality of unit display regions adjacent to each other is visible in different directions by separating light from the plurality of pixels into light beams directing in different directions. The image display program causes the control portion to function as: an image signal supply unit which makes the plurality of pixels belong to one pixel group or a plurality of pixel groups and supplies an identical image signal to the pixels belonging to one pixel group and different image signals to the pixels belonging to different pixel groups; and a selection unit which selects the number of pixel groups or the number of pixels included in each pixel group. According to this program, it is possible to change viewing angles of display images with high precision without modifying the structure of the image display device.

### BRIEF DESCRIPTION OF THE DRAWINGS

The invention will be described with reference to the accompanying drawings, wherein like numbers reference like elements.

FIG. 1 is a cross-sectional view illustrating an image display device according to one embodiment of the invention.

FIG. 2 is a plan view illustrating a liquid crystal panel of the image display device according to the embodiment.

FIG. 3 is a plan view illustrating a liquid crystal panel of the image display device according to the embodiment.

FIG. 4 is a circuit diagram illustrating a portion of a drive circuit of the image display device according to the embodiment.

FIG. 5 is a schematic view illustrating an image display device performing eight-picture display.

FIG. 6 is a plan view illustrating a liquid crystal panel performing eight-picture display.

FIG. 7 is a schematic view illustrating an image display device performing left and right equal size two-picture display.

FIG. 8 is a plan view illustrating a liquid crystal panel performing left and right equal size two-picture display.

FIG. 9 is a schematic view illustrating an image display device performing left and right unequal two-picture display.

FIG. 10 is a plan view illustrating a liquid crystal panel performing left and right unequal two-picture display.

FIG. 11 is a schematic view illustrating an image display device performing three-picture display.

FIG. 12 is a plan view illustrating a liquid crystal panel performing three-picture display.

FIG. 13 is a schematic view illustrating an image display device performing three-dimensional display.

FIG. 14 is a plan view illustrating a liquid crystal panel performing three-dimensional display.

FIG. 15 is a schematic view illustrating an image display device according to one modification.

FIG. 16 is a schematic view illustrating an image display device according to one modification.

FIG. 17 is an electronic apparatus to which the image displaying device of the invention is applied.

### DESCRIPTION OF EXEMPLARY EMBODIMENTS

Embodiments of the invention will be described below with reference to the accompanying drawings.

### Image Display Device

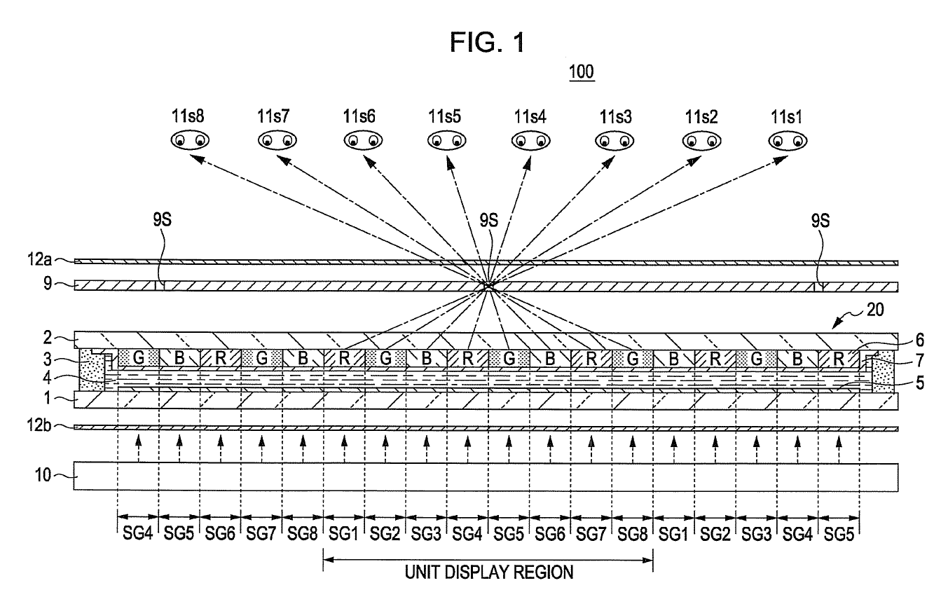

FIG. 1 is a cross-sectional view illustrating an image display device 100 according to this embodiment. The image display device 100 according to this embodiment has a parallax barrier system. Accordingly, the image display device 100 can perform a dual-image display by which different images can be viewed by to a plurality of different view points 11s1 to 11s8 in different viewing positions.

As shown in FIG. 1, the image display device 100 according to this embodiment mainly includes a parallax barrier 9, a liquid crystal panel 20, and a lighting device 10.

The liquid crystal panel 20 has a structure in which substrates 1 and 2 are attached to each other with a sealing member 3 in between. Liquid crystals 4 are sealed in a gap between the substrates 1 and 2. Pixel electrodes 5 are formed on the substrate 1 so as to correspond to every dot of sub-pixels SG1 to SG8 and colored layers 6 (color filters) in R, G, and B and an opposing electrode 7 are formed on the substrate 2. The colored layers 6 in R, G, and B are formed corresponding to positions of the pixel electrodes 5. The opposing electrode 7 is formed covering the entire surface of the substrate 2. In FIG. 1, the colored layers 6 in R, G, and B are denoted “R”, “G”, and “B”.

The lighting device 10 is disposed on the rear side of the liquid crystal panel 20. The lighting device 10 illuminates so as to allow light therefrom to pass through the liquid crystal panel 20. A lower polarizing plate 12b is disposed between the liquid crystal display panel 20 and the lighting device 10.

A light emitting surface of the liquid crystal panel 20 is provided with a parallax barrier 9. The parallax barrier 9 is provided with a plurality of slits 9S formed at predetermined intervals. The parallax barrier 9 serves as a transmissive region, which is transmissive to light only at the portion with the slits 9S, and also an opaque region which is not transmissive to light at the other portions. The slits 9S are formed in the parallax barrier 9 such that they are positioned corresponding to intermediate portions between colored layers 6 or between pixel electrodes 5 in the liquid crystal panel 20. For example, the slit 9S is formed so as to correspond to an intermediate portion between a sub-pixel SG4 and a sub-pixel SG5. The light emitting surface of the parallax barrier 9 is provided with an upper polarizing plate 12a.

Light beams emitted from lighting device 10 are incident onto the liquid crystal panel 20, then penetrate through the colored layers 6 and finally exit from the liquid crystal panel 20. The light beams exiting from the liquid crystal panel 20 pass through the slits 9S and reach a plurality of view points 11s1 to 11s8 positioned at different viewing positions. In greater detail, the light beam exiting from the sub-pixel SG1 of the liquid crystal panel 20 passes through the slit 9S and reaches the view point 11s1 while the light beam exiting from the sub-pixel SG2 of the liquid crystal panel 20 passes through the slit 9S and reaches the view point 11s2. In a similar manner, the light beams exiting from the sub-pixels SG3 to SG8 of the liquid crystal panel 20 pass through the slit 9S and reach the view points 11s3 to 11s8. The parallax barrier 9 is positioned so as to face the liquid crystal panel 20 such that the slit 9S is positioned corresponding to the intermediate portion between the sub-pixel SG4 and the sub-pixel SG5. With such a structure, light beams exiting from the sub-pixels SG1 to SG8 reach the view points 11s3 to 11s8, respectively. In a similar manner, as for another slit 9S adjacent to the above slit 9S, since the parallax barrier 9 is positioned so as to face the liquid crystal panel 20 such that the relevant slit is positioned corresponding to the intermediate portion between the sub-pixel SG4 and the sub-pixel SG5, the light beams exiting from the sub-pixels SG1 to SG8 reach the view points 11s3 to 11s8, respectively. As the light beams, which exit from the sub-pixels SG1 to SG8 after passing through the plurality of slit 9S, gather, images to be displayed are displayed to the view points 11s1 to 11s8.

Hereinafter, a region of the sub-pixels SG at which the light is separated into light beams directed in different directions by one slit 9S in the above manner, i.e. a region of the sub-pixels SG1 to SG8 herein, is called “unit display region.”

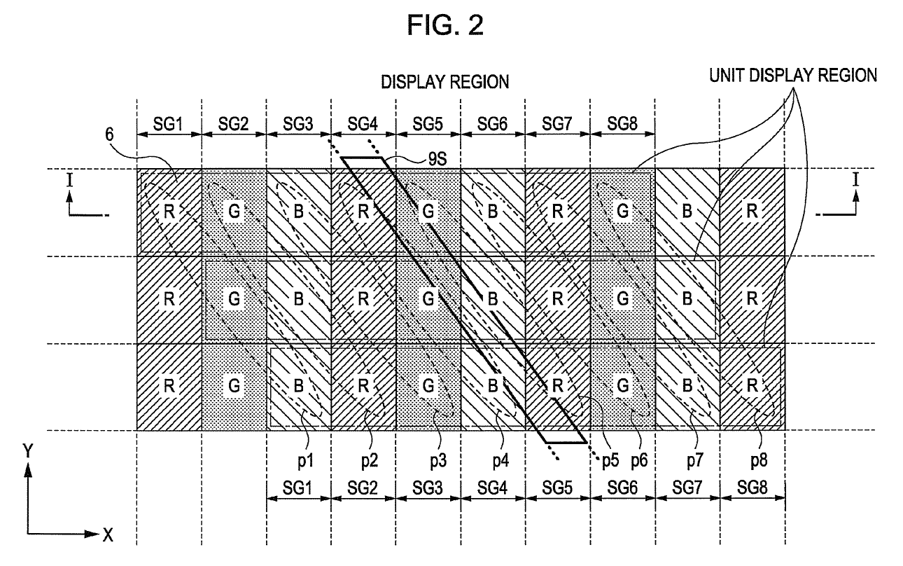

FIG. 2 is a plan view illustrating the liquid crystal panel 20 of the image display device 100, and more particularly a display region at which an image is displayed. The liquid crystal panel 20 of the image display device 100 shown in FIG. 1 is a sectional view taken along cut line I-I in a plan view of the liquid crystal panel 20 shown in FIG. 2. In FIG. 2, colored layers 6 of RGB colors are denoted “R,” “G” and “B.” In FIG. 2, the slit 9S is demarcated by a thick solid line in the form of a frame whereas the unit display regions are demarcated by a dashed line. In FIG. 2, the arrangement direction of the sub-pixels SG1 to SG8 in the unit display region is in an X direction and the Y direction is in a direction perpendicular to this X direction.

In the image display device 100 according to this embodiment, as shown in FIG. 2, the unit display regions on adjacent rows are set such that they are misaligned with each other in the X direction, i.e. the arrangement direction of the sub-pixels by the amount of one column, i.e. by a distance of one sub-pixel. Accordingly, when considering the unit display regions as much as three rows, each of the sub-pixels SG1 to SG8 is a sub-pixel of a single color among RGB colors.

One pixel (color pixel) is composed of the sub-pixels of RGB colors. FIG. 2 shows pixels p1 to p8. In more detail, the pixel p1 is composed of the sub-pixels SG1 of RGB colors and the pixel p2 is composed of the sub-pixels SG2 of RGB colors. In this manner, each of the pixels p3 to p8 is composed of the RGB sub-pixels SG3, SG4, SG5, SG6, SG7, or SG8, respectively.

Next, the shape of the slit 9S will be described. The parallax barrier 9 is placed such that the slit 9S is positioned at the center of the unit display region. In other words, the parallax barrier 9 is placed such that the slit 9S is positioned corresponding to an intermediate portion between the sub-pixel SG4 and the sub-pixel SG5. Here, since the unit display regions on adjacent rows are set such that they are misaligned with each other by the amount of one sub-pixel, the sub-pixels SG4 and SG5 existing on adjacent rows are misaligned with each other by the amount of one sub-pixel from each other. Accordingly, as shown in FIG. 2, the slits 9S are formed in the parallax barrier 9 such that they are diagonal to the X direction only by the amount of one sub-pixel, which is the amount of misalignment between the sub-pixels SG4 and SG5 (i.e. the amount of misalignment of unit display regions).

The inclination direction of the slit 9S is not limited to the X direction. That is, the inclination direction of the slit 9S is the misalignment direction in which the adjacent unit display regions are misaligned with each other. For example, in the case in which the misalignment direction, in which the adjacent unit display regions are misaligned, is the Y direction of FIG. 2, the inclination direction of the slits 9S becomes the Y direction.

In the case of displaying different images to the plurality of view points 11s1 to 11s8, the image data is displayed in the unit of a pixel among the pixels p1 to p8. Although it will be described in detail later, the image displayed, for example, to the view point 11s1 is composed of image data supplied to the sub-pixels SG1 of RGB colors included in the pixel p1 while the image displayed to the view point 11s2 is composed of image data supplied to the sub-pixels SG2 of RGB colors included in the pixel p2. In this manner, each of the images displayed to the view points 11s3 to 11s8 is composed of image data supplied to each of the sub-pixels SG3 to SG8 of RGB colors included in the pixels p3 to p8, respectively.

The slits 9S are formed in the parallax barrier such that the slits 9 are positioned at the center of the unit display region. Further, the unit display regions on adjacent rows are misaligned with each other by the amount of one sub-pixel, in which the slit 9S is positioned at the intermediate portion between the sub-pixel SG4 and the sub-pixel SG5 at any row. The image display device 100 according to this embodiment can perform display with respect to the view points 11s1 to 11s8 using each of the pixels p1 to p8 as one pixel through the slit 9S. That is, the image data to be presented to the view points 11s1 to 11s8 are supplied, so that the pixel can be displayed. The aggregation of pixels supplied with the same image data (the pixels being composed of sub-pixels of RGB colors) corresponds to “group” in this invention. For example, like the pixel p1, the pixel displaying the image data to be displayed to the view point 11s1 belongs to the same group as the pixel p1. Since the pixel p1 and the pixel p2 display different image data, respectively, they belong to different groups, respectively.

As described with reference to FIG. 1, a plurality of slits 9S is formed in the parallax barrier 9 at predetermined intervals. Accordingly, in the image display device 100 according to this embodiment, light beams from the pixels, to which the image data are displayed, gather passing through the plurality of slits 9S and, therefore, it is possible to display images to be displayed to the view points 11s1 to 11s8, respectively.

Here, the reason of the structure in which the unit display regions existing on adjacent rows are misaligned with each other in the X direction by the amount of one sub-pixel will be described. In general image display devices, for example, sub-pixels of RGB colors constituting one pixel supplied with image data to be displayed to the view point 11s1 are arranged on the first column of FIG. 2, i.e. in the Y direction of FIG. 2. In this case, the resolution in the X direction of the image data corresponding to the display region is lowered to ⅛ of the resolution of the original image data. On the other hand, in the case in which the unit display regions on adjacent rows are placed with misalignment, as shown in FIG. 2, the sub-pixels of RGB colors, constituting the pixel of the image data to be displayed to the view point 11s1, are diagonally placed over the first to third columns. Accordingly, the resolution of the image data of the display region in the X direction is lowered to ⅜ of the resolution of the original image, that is, the resolution deterioration is suppressed. Accordingly, in the image display device according to this embodiment, with the structure in which the unit display regions on adjacent columns are placed with misalignment, it is possible to reduce the deterioration feeling of resolution in comparison with general image display devices.

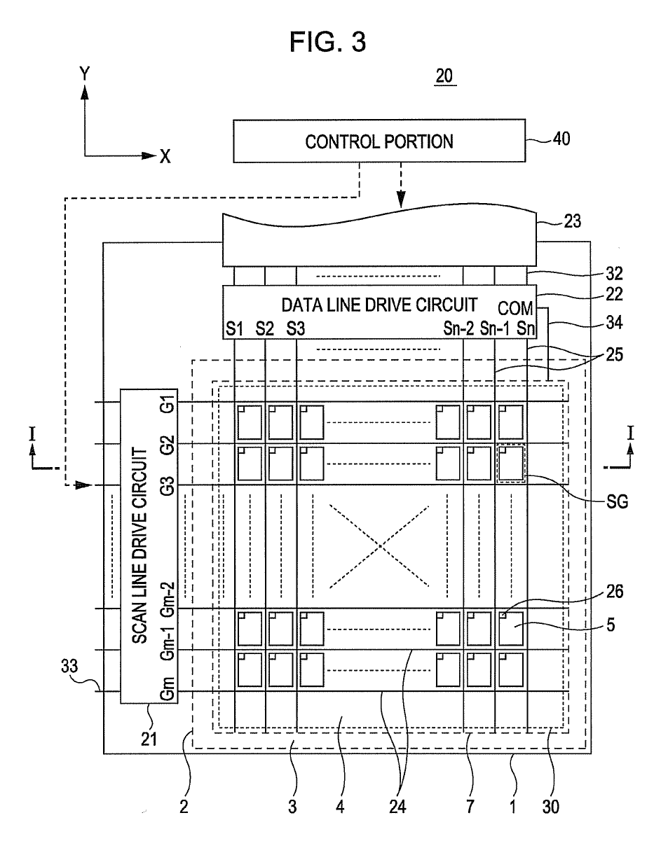

Next, the structure of a drive circuit of the liquid crystal panel 20 will be described. FIG. 3 is a plan view illustrating the structure of the drive circuit of the liquid crystal panel 20 of the image display device 100. The view of the liquid crystal panel 20 of the image display device 100 shown in FIG. 1 is a sectional view taken along the cut line I-I of the plan view of the liquid crystal panel 20 shown in FIG. 3.

On the inside surface of a substrate 1, a plurality of scan lines 24 and a plurality of data lines 25 are placed in a matrix, and every intersection of the scan lines 24 and the data lines 25 is provided with a switching element 26, such as a thin-film transistor (TFT). In the display region 30, each of the regions isolated by the plurality of scan lines 24 and the plurality of data lines 25 form a sub-pixel SG. Each of the sub-pixels SG is provided with a pixel electrode 5, and the pixel electrode 5 is electrically connected to the switching element 26.

In greater detail, the substrate 1 has extended portions protruding from the substrate 2 in the X direction and the Y direction. A scan line driving circuit 21 is arranged on the extended portion in the X direction of the substrate 1 and a data line driving circuit 22 is arranged on the extended portion in the Y direction of the substrate 1.

Each of data lines 25 denoted by reference characters S1, S2, S3 . . . , Sn (n is a natural number) extends in the Y direction and the data lines 25 are arranged in the X direction at regular intervals. An end of each of the data line 25 is electrically connected to the data line driving circuit 22. The data line driving circuit 22 is electrically to an FPC 23 via a wiring 32. The FPC 23 is electrically connected to an external electronic apparatus. The data line driving circuit 22 receives a control signal from a control unit 40 of the external electronic apparatus via the FPC 23. The data line driving circuit 22 supplies data signals to the data lines denoted by reference characters S1, S2, S3 . . . , Sn on the basis of the control signal.

Each of the scan lines 24 denoted by reference characters G1, G2, G3 . . . , Gm (m is a natural number) extends in the X direction, and the scan lines 24 are arranged in the Y direction at regular intervals. An end of the scan line 24 is electrically connected to the scan line driving circuit 21. The scan line driving circuit 21 is electrically connected to a wiring 33 and the wiring 33 is electrically to the external electronic apparatus. The scan line driving circuit 21 receives a control signal from the control unit 40 of the external electronic apparatus via the wiring 33. The scan line driving circuit 21 sequentially supplies scan signals to the scan lines 24 denoted by reference characters G1, G2, G3 . . . , and Gm on the basis of the control signal.

The opposing electrode 7 is electrically connected to the data line driving circuit 22 via a wiring 34 denoted by reference character COM. The data line driving circuit 22 supplies a driving signal to the opposing electrode 7 via the wiring 34 on the basis of the control signal from the external electronic apparatus, thereby driving the opposing electrode 7.

The scan line driving circuit 21 selectively and exclusively selects the data lines 24 in order of G1, G2, G3, . . . , Gm on the basis of the control signal from the control unit 40 and supplies the scan signal to the selected scan line 24. The data line driving circuit 22 supplies the data signals corresponding to display content to the pixel electrodes 5 disposed so as to correspond to the scan lines 24 selected on the basis of the control signal from the control unit 40, via the corresponding data lines 25. By such processing, an electric potential is applied to the pixel electrode 5 and thus liquid crystal molecules in the liquid crystals 4 disposed between the pixel electrodes 5 and the opposing electrode 7 come to be arranged in a display state or a half-ton display state so that it is possible to display a desired image on the liquid panel 20. That is, the control unit 40 can control the scan signals and the data signals supplied to the plurality of scan lines 24 and the plurality of data lines 25 by supplying the control signal to the scan line driving circuit 21 and the data line driving circuit 22, and the control unit 40 can display a desired image on the liquid crystal panel 20.

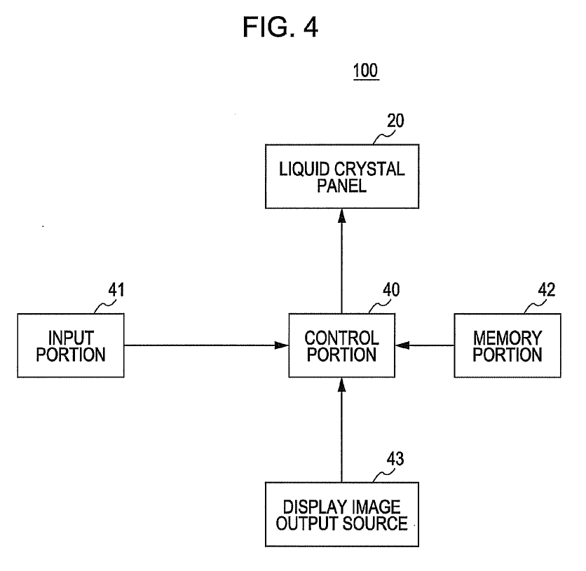

FIG. 4 is a schematic view illustrating control sequence of the drive circuit of the image display device 100. The image display device 100 further includes an input portion 41, a storage portion 42, and a display information output source 43 in addition to a control portion 40.

The display information output source 43 includes a memory composed of a read only memory (ROM) or a random access memory (RAM), a storage unit composed of a magnetic recording disk or an optical recording disk, and a synchronizing circuit synchronously outputting digital image signals. The display information source 43 is structured to supply image signals in a predetermined format to the control portion 40 on the basis of various kinds of clock signals generated by a timing generator (not shown).

The input portion 41 allows a user to input his or her choice of display change. The choice of display changes includes changes to the number of view points and switches between two-dimensional display and three-dimensional display. The input portion 41 supplies a detection signal corresponding to the demand of the display change input by the user to the control portion 40.

The control portion 40 is, for example, a central processing unit (CPU). It generates a control signal on the basis of an image signal (image data) supplied from the display image output source 43 and then supplies the generated control signal to the liquid crystal panel 20, i.e., the scan line drive circuit 21 and the data line drive circuit 22 of the liquid crystal panel 20. The control portion 40 generates the control signal for the display change demand from the user on the basis of the image signal from the display image output source 43 when it receives the detection signal by the input portion 41, and then supplies the generated control signal to the scan line drive circuit 21 and the data line drive circuit 22 of the liquid crystal panel 20. The storage portion 42 is, for example, a memory unit and is connected to the control portion 40. The above processing of the control portion 40 is performed by, for example, a program. Accordingly, the storage portion 42 bears a program for performing the above processing. In the above embodiment, the control portion 40 may not be limited to the form in which it is incorporated into an external electronic apparatus. For example, it may be realized as an IC chip provided in the FPC 23 or a main body of the liquid crystal panel 20.

The image display device 100 according to the embodiment can diversely change display modes without modifying the device structure. For example, the image display device 100 can perform two-picture displays or three-picture displays by changing the number of view points, and can also perform three-dimensional display. In greater detail, the display mode can be diversely changed when the control portion 40 selects the number of groups or the number of pixels included in each group with respect to the plurality of input images on the basis of the display change demand from the user, for example, the view point. Accordingly, the control portion 40 serves as the image signal supply unit and the selection unit of the invention. The details will be described later.

### Image Display Method

Next, an image display method of the image display device 100, for example, an eight-picture display method, a two-picture display method and a three-dimensional display method, will be described.

### Eight-Picture Display Method

First, the eight-picture display method will be described.

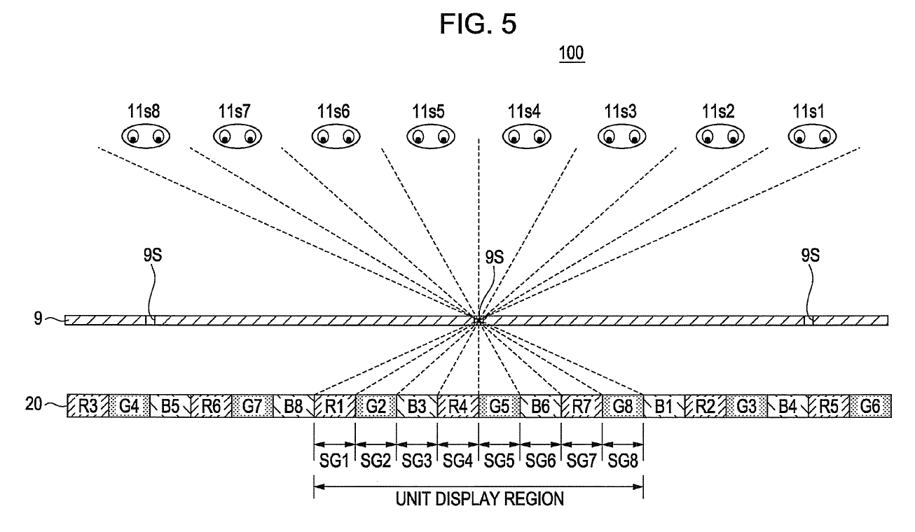

FIG. 5 is a schematic view illustrating the image display device 100 according to the embodiment. In FIG. 5, the liquid crystal device 20 is shown in a simplified manner. In the following description, the liquid crystal panel 20 will be shown in this simplified manner. In more detail, in the liquid crystal panel 20 in FIG. 5 the displayed image data is shown sub-pixel by sub-pixels SG. The image data is composed of plural pieces of pixel data displayed to the plurality of pixels, respectively, and each piece of the pixel data is composed of sub-pixel data of RGB colors (i.e. red (R) data, green (G) data and blue (B) data).

In FIG. 5, alphabetical letters R, G and B stand for sub-pixel data of RGB colors, respectively. Numeral characters 1 to 8 represent 8 pieces of different image data 1 to 8. For example, the pixel data “R1” represents pixel data for a red sub-pixel of the image data 1, the pixel data “G2” represents pixel data for a green sub-pixel of image data 2, and the pixel data “B3” represents pixel data for a blue sub-pixel of image data 3.

As described above, the light emitted from the sub-pixels SG1 to SG8 of the liquid crystal panel 20 is separated into light beams directed in different directions by the slit 9S. Accordingly, the light beams emitted from the sub-pixels SG1 to SG8 of the liquid crystal panel 20 reach the view points 11s1 to 11s8, respectively.

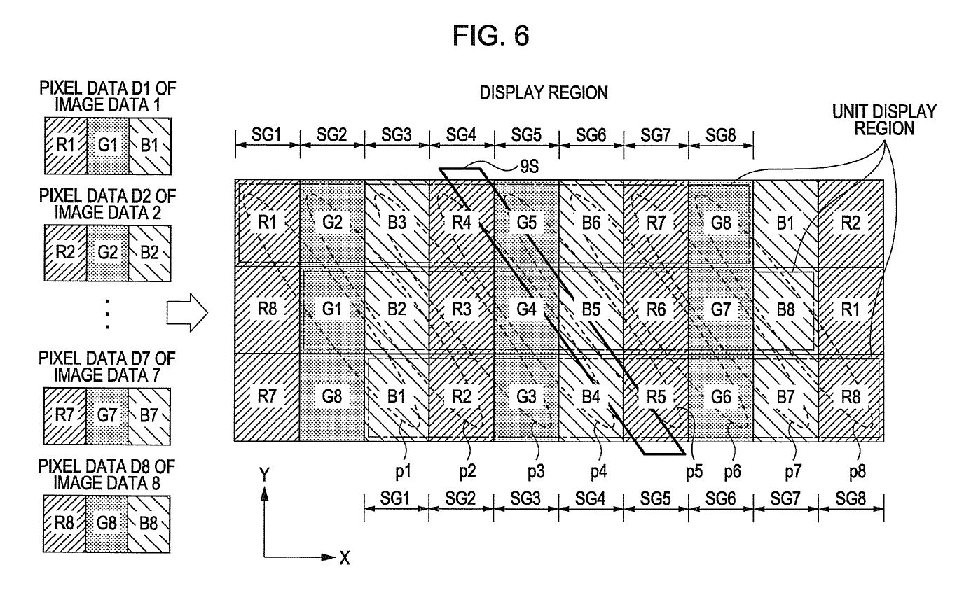

FIG. 6 is a plan view illustrating the liquid crystal panel 20 of the image display device 100.

As the image display method, the control portion 40 extracts pixel data to be displayed to the pixels composed of the sub-pixels of RGB colors by the image data 1 to 8. In the example shown in FIG. 6, pixel data D1 extracted by the image data 1 is composed of sub-pixel data R1, G1 and B1. Pixel data D2 extracted by the image data 2 is composed of sub-pixel data R2, G2 and B2. In this manner, as shown in FIG. 6, each of pixel data D3 to D8 extracted by the image data 3 to 8, respectively, is composed of relevant RGB sub-pixel data.

Next, the control portion 40 places the pixel data D1 to D8 of the image data 1 to 8 on the pixels p1 to p8 of the liquid crystal panel 20. In greater detail, the control portion 40 supplies the pixel data of the same image data on the pixels which belong to one group and the pixel data of different image data on pixels which belong to different groups in the liquid crystal panel 20. The details will be described later.

First, as for the unit display regions of the first row of the display region, a method of producing an image of a first row of the display region will be described in detail. The control portion 40 places the sub-pixel data R1 of the image data 1 on the sub-pixel on the first column, the sub-pixel data G2 of the image data 2 on the sub-pixel on the second column, and the sub-pixel data B3 of the image data 3 on the sub-pixel on the third column. In this manner, as for the unit display regions on the first row, the control portion 40 places the sub-pixel data R4 to G8 of the image data 4 to 8 on the sub-pixels from the fourth column to the eighth column in the RGB order. In this manner, the control portion 40 repeats manipulation by placing the sub-pixel data of the image data 1 to 8 on the sub-pixels on from the ninth column or below which are in a neighboring unit display region. With this operation, the control portion 40 produces the image of the first row of the display region.

Next, a method for producing the image of the second row of the display region is detailed below. In the image display device 100 according to this embodiment, as described before, the unit display regions existing on adjacent rows are set to be misaligned by the amount of one sub-pixel. Accordingly, as the second row, the control portion 40 places the sub-pixel data of the image data 1 to 8 by shifting the sub-pixel data from positions of the sub-pixel data of the image data 1 to 8 of the first row of the display region. In more detail, as for the second row, the control portion 40 places the sub-pixel data G1 of the image data 1 on the sub-pixel of the second column, the sub-pixel data B2 of the image data 2 on the sub-pixel of the third column, and the sub-pixel data R3 of the image data 3 on the sub-pixel of the fourth column. In this manner, the control portion 40 places the sub-pixel data G4 to B8 of the image data 4 to 8 on the sub-pixels of the fifth, sixth, seventh, eighth and ninth columns, respectively in the GBR order. As for the sub-pixels on the tenth column or below, the control portion 40 repeats manipulation by placing the sub-pixel data of the image data 1 to 8 in such a manner. With this operation, the control portion 40 produces the image of the second row of the display region.

Further, in this manner, with respect to the third row or below, the control portion 40 places the sub-pixel data B1 to R8 of the image data 1 to 8 on the sub-pixels from the third column by shifting the sub-pixel data from the sub-pixel data positions of the image data 1 to 8 on the second row of the display region. At this time, when considering the first to third rows of the display region, as shown in FIG. 6, the pixel data D1 to D8 are placed on the pixels p1 to p8, respectively, since the pixel data D1 to D8 are image data constituting different image data. In this case, the pixels p1 to p8 belong to different groups.

With this manner, in the image display device 100 according to this embodiment, it is possible to display the image data D1 to D8 of the image data 1 to 8, which are to be displayed to the view points 11s1 to 11s8, respectively, through the slit 9S. Further, it is possible to perform an eight-picture display for displaying the image data 1 to 8, which are different from each other, to the view points 11s1 to 11s8 because the light from the pixels to which the image data 1 to 8 are displayed gathers while passing through each of the plurality of slits 9S.

### Two-Picture Display Method

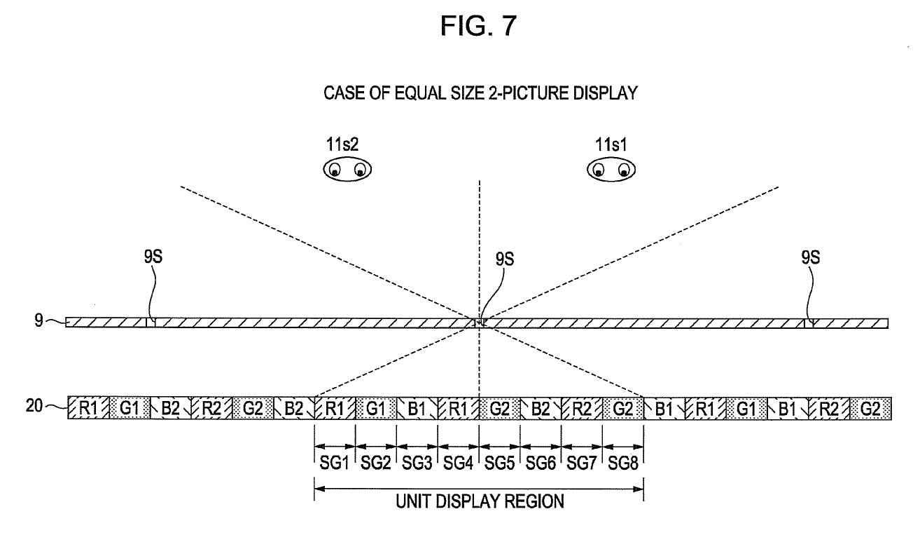

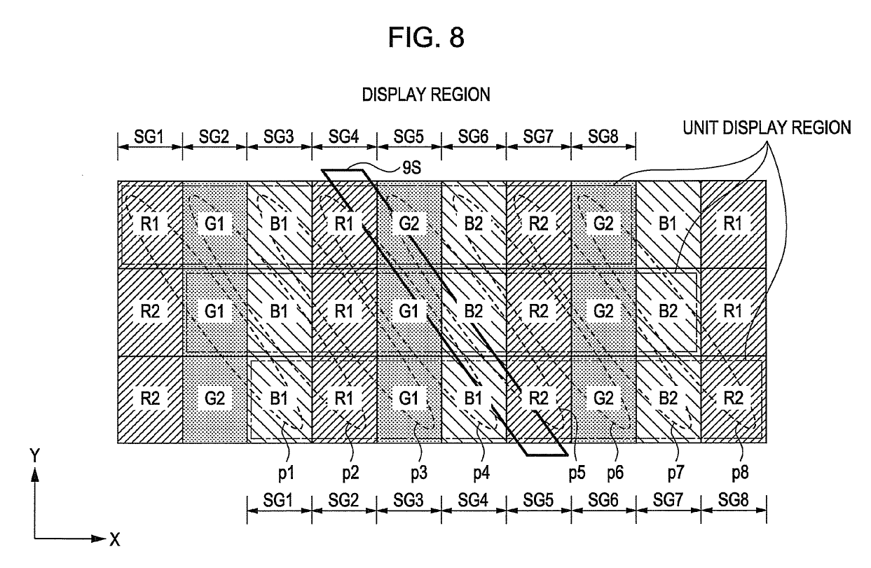

Next, a two-picture display method will be described. First, the case in which left and right pictures are equal in size will be described with reference to FIGS. 7 and 8.

FIG. 7 is a schematic view illustrating the image display device 100 performing left and right equal two-picture display. In the image display device 100 shown in FIG. 7, image data 1 and 2 are displayed to view points 11s1 and 11s2 positioned at left and right viewing positions in a left-light equal form. In the case of performing such two-picture display, the control portion 40 places the sub-pixel data of the image data 1 on the sub-pixels SG1 to SG4, and the sub-pixel data of the image data 2 on the sub-pixels SG5 to SG8. The reason for such a placement is to uniformly separate the light emitted from the sub-pixels SG1 to SG8 so that the light emitted from the sub-pixels SG1 to SG4 reaches the view points 11s1 and the light emitted from the sub-pixels SG5 to SG8 reaches the view point 11s2 in the case of performing left and right equal two-picture display. That is, it is possible to equalize the viewing angles of the image data 1 and the image data 2 by uniformly dividing the sub-pixels SG1 to SG8 into groups and placing the sub-pixel data of the image data 1 on the sub-pixels SG1 to SG4 and the sub-pixel data of the image data 2 on the sub-pixels SG5 to SG8, and it is possible to equalize the size of the display range of the image data 1 and the size of the display range of the image data 2.

FIG. 8 is a plan view illustrating the liquid crystal panel 20 of the image display device 100.

As shown in FIG. 8, in the case of performing the two-picture display, in the region corresponding to the unit display regions on the first row of the display region, the sub-pixel data are placed in the order of R1, G1, B1, R1, G2, B2, R2, G2, and in the region corresponding to the unit display regions on the second row of the display region, the sub-pixel data are placed in the order of G1, B1, R1, G1, B2, R2, G2, and B2. In this manner, in the region corresponding to the unit display regions on the third row of the display region, the sub-pixel data are arranged in the order of B1, R1, G1, B1, R2, G2, B2, and R2. That is, when considering the display region, and particularly from the first to third rows of the display region, as shown in FIG. 8, the pixel data D1 is placed on the pixels p1 to p4, and the pixel data D2 is placed on the pixels p5 to p8. Accordingly, in this case, the pixels p1 to p4 belong to one group and the pixels p5 to p8 belong to one group. On the other hand, the pixels from p1 to p4 and the pixels from p5 to p8 belong to different groups.

As described above, in the image display device 100 according to the embodiment, it is possible to display the pixel data D1 and the pixel data D2 of the image data 1 and 2 to be displayed to the view points 11s1 to 11s2 through the slit 9S. Accordingly, since the light from the pixels, to which the image data 1 and the image data 2 are displayed, gather passing through the plurality of slits 9S, the two-picture display for displaying different image data 1 and 2 can be performed with respect to the view points 11s1 and 11s2. Here, when comparing the case of the eight-picture display (FIG. 6) with the two-picture display (FIG. 8), it is found that the case of the two-picture display is larger in the display range of each of the image data 1 and the image data 2 than the case of the eight-picture display. That is, in the predetermined image, as the number of sub-pixels to be displayed in the unit display region is larger, the display range of the predetermined image becomes wider.

In the case of switching the eight-picture display of the image data 1 to 8 to the left and right equal two-picture display of the image data 1 and 2, the control portion 40 performs the control of replacing the sub-pixel data of the image data 1 placed only on the sub-pixel SG1 on the sub-pixels SG1 to SG4 and the sub-pixel data of the image data 2 placed only on the sub-pixel SG2 on the sub-pixels SG5 to SG8. With this operation, it is possible to perform switching from the eight-picture display to the two-picture display.

However, in the case of switching the two-picture display to the eight-picture display, the control portion 40 performs the control of placing the sub-pixel data of the image data 1 placed on the sub-pixels SG1 to SG4 on only the sub-pixel SG1 and the sub-pixel data of the image data 2 placed on the sub-pixels SG5 to SG8 on only the sub-pixel SG2. The control portion 40 obtains the pixel data of the image data 3 to 8 on the basis of the image signal from the display image output source 43 and performs the control of placing the sub-pixel data constituting the pixel data of the image data 3 to 8 on the sub-pixels SG3 to SG8, respectively. In this manner, for each of the plurality of input images, it is possible to change the two-picture display to the eight-picture display by changing the number of displayed sub-pixels in the unit display region.

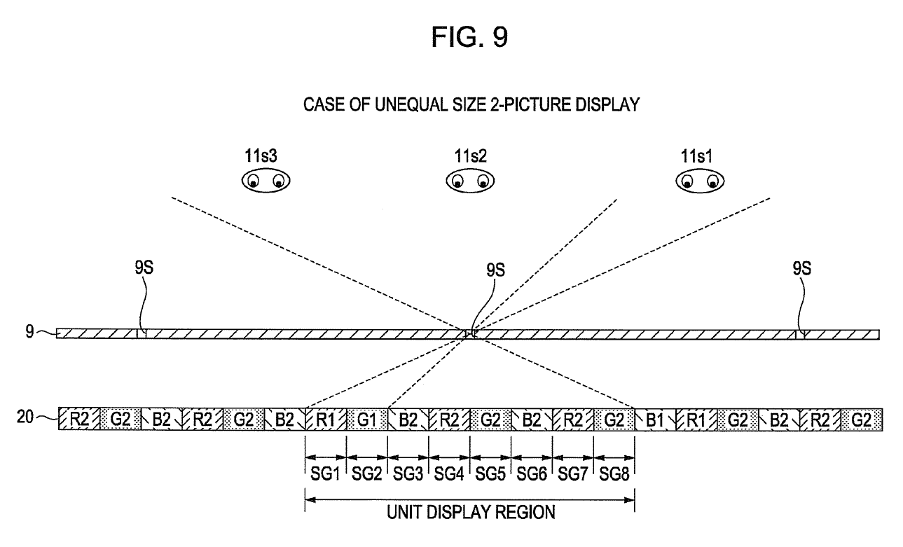

Next, as an example of another two-picture display method, the case of performing the left and right unequal two-picture display will be described with reference to FIG. 9. FIG. 9 is a schematic view illustrating the image display device 100 in the case of performing the left & right unequal two-picture display.

In the image display device 100 shown in FIG. 9, the image data 1 is displayed to the view point 11s1 among the view points 11s1, 11s2, and 11s3 positioned at different viewing positions and the image data 2 is displayed to the view points 11s2 and 11s3. In this case, the display range of the image data 2 needs to be larger than the display range of the image data 1. In other words, the viewing angle of the image data 2 needs to be larger than the viewing angle of the image data 1. Accordingly, in the example of FIG. 9, the transmission covering range of the light emitted from the sub-pixels SG1 to SG2 is set as the display covering range of the image data 1, and the transmission covering range of the light emitted from the sub-pixels SG3 to SG8 is set as the display covering range of the image data 2. That is, the control portion 40 places the sub-pixel data of the image data 1 on the sub-pixels SG1 and SG2 and the sub-pixel data of the image data 2 on the sub-pixels SG3 to SG8.

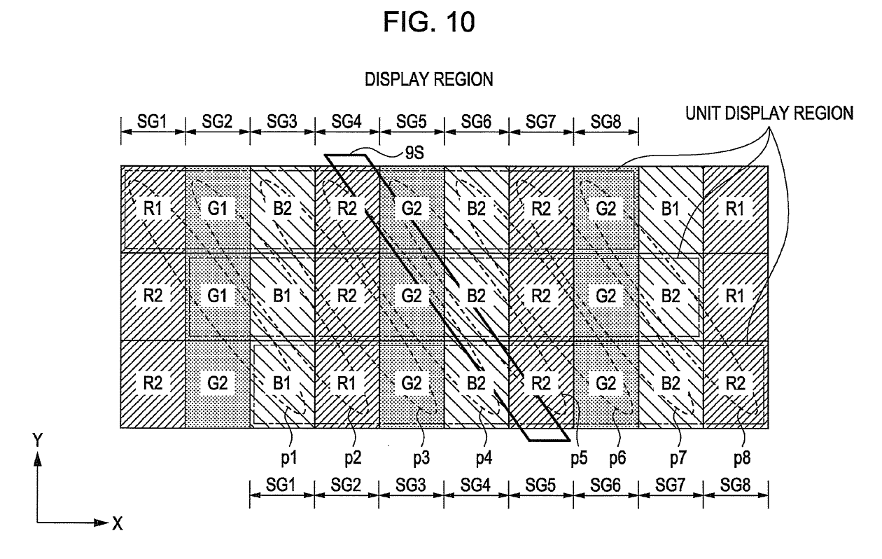

FIG. 10 is a plan view illustrating the liquid crystal panel 20 of the image display device 100 when performing the left and right unequal two-picture display.

As shown in FIG. 10, in the case of performing the left and right unequal two-picture display, in the region corresponding to the unit display regions on the first row of the display region, the sub-pixel data are placed in the order of R1, G1, B2, R2, G2, B2, R2, and G2. In the region corresponding to the unit display regions on the second row of the display region, the sub-pixel data are placed in the order of G1, B1, R2, G2, B2, R2, G2, and B2. In the region corresponding to the unit display regions on the third row of the display region, the sub-pixel data are placed in the order of B1, R1, G2, B2, R2, G2, B2, and R2. That is, when considering the display region in the range from the first row to the third row, as shown in FIG. 10, two pieces of pixel data D1 and six pieces of pixel data D2 are arranged side by side.

With such arrangement, it is possible to make the viewing angle of the image data 2 larger than the viewing angle of the image data 1, display the image data 1 to the view point 11s1 and display the image data 2 to the view points 11s2 and 11s3.

As can be seen from the above, in the plurality of unit display regions adjacent to each other, it is possible to make the viewing angle of the image data 2 larger than the viewing angle of the image data 1 by setting the number of the pixels to which the image data 2 is displayed to be larger than the number of the pixels to which the image data 1 is displayed. In other words, the control portion 40 can differently set the viewing angles of a plurality of images by differently setting the number of pixels, to which the image data is displayed, in the plurality of unit display regions adjacent to each other.

### Three-Picture Display Method

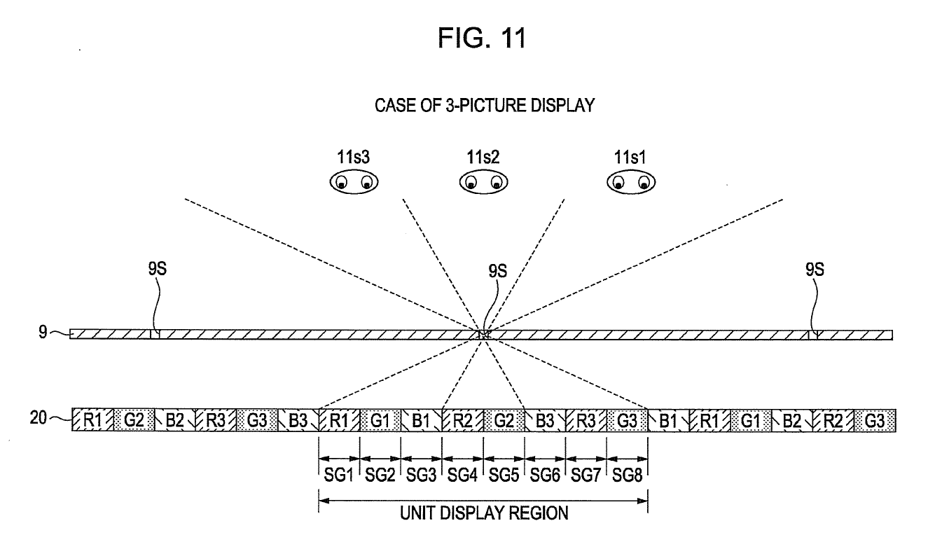

Next, the case of performing three-picture display will be described with reference to FIG. 11. FIG. 11 is a schematic view illustrating the image display device 100 in the case of performing the three-picture display.

In the image display device 100 shown in FIG. 11, among the view points 11s1, 11s2, and 11s3 positioned at different viewing positions, the image data 1 is displayed to the view point 11s1, the image data 2 is displayed to the view point 11s2, and the image data 3 is displayed to the view point 11s3. In this case, the sub-pixels SG1 to SG8 in the unit display region are divided into three groups, and the sub-pixel data of the image data 1, 2, and 3 are placed on the three groups, respectively. In the example of FIG. 11, the control portion 40 places the sub-pixel data of the image data 1 on the sub-pixels SG1 to SG3, the sub-pixel data of the image data 2 on the sub-pixels SG4 and SG5, and the sub-pixel data of the image data 3 on the sub-pixels SG6 to SG8.

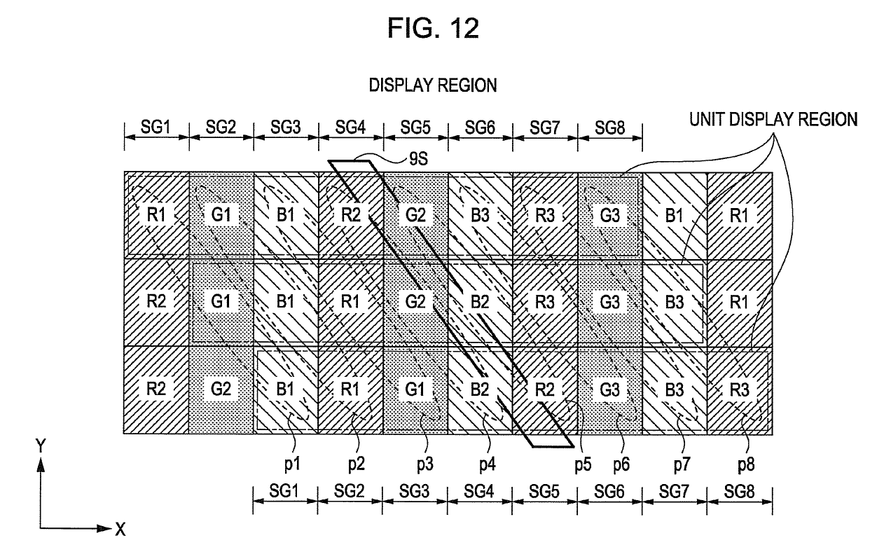

FIG. 12 is a plan view illustrating the liquid crystal panel 20 of the image display device 100 in the case of performing the three-picture display.

As shown in FIG. 12, in the case of performing the three-picture display, in the region corresponding to the unit display region on the first row of the display region, the sub-pixel data are placed in the order of R1, G1, B1, R2, G2, B3, R3, and G3. In the region corresponding to the unit display region on the second row of the display region, the sub-pixel data are placed in the order of G1, BE1, R1, G2, B2, R3, G3, and B3. In the region corresponding to the unit display region on the third row of the display region, the sub-pixel data are placed in the order of B1, R1, G1, B2, R2, G3, B3, and R3. That is, when considering the display region in the range from the first row to the third row, as shown in FIG. 12, the pixel data D1 is placed on the pixels p1 to p3, the pixel data D2 is placed on the pixels p4 to p5, and the pixel data D3 is placed on the pixels p6 to p8. Accordingly, in this case, the pixels p1 to p3 belong to the same group, the pixels p4 to p5 belong to the same group, and the pixels p6 to p8 belong to the same group.

With this placement, the image display device 100 can display the pixel data D1 to D3 of the image data 1 to 3, respectively, to be displayed through the slit 9S to the view points 11s1 to 11s3. Further, with the method in which the light beams from the pixels, to which the image data 1 to 3 are displayed, gather passing through the plurality of slits 9S, the image data 1 can be displayed to the view point 11s1, the image data 2 can be displayed to the view point 11s2, and the image data 3 can be displayed to the view point 11s3. That is, the image display device 100 can perform the three-picture display.

As can be seen from the above, in the case of performing the two-picture, three-picture, four-picture, five-picture, six-picture, seven-picture, and eight-picture display, the sub-pixels SG1 to SG8 in the unit display region are divided into 2 to 8 groups, and the sub-pixel data of different image data are placed group by group. In other words, it is enough that the control portion 40 selects the number of groups or the number of pixels included in each of the groups in the plurality of unit display regions adjacent to each other.

### Three-Dimensional Display Method

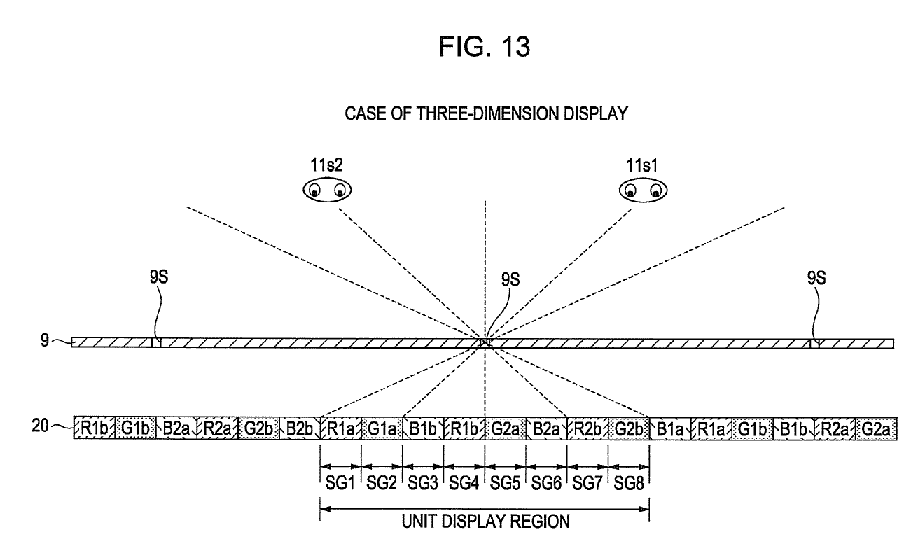

Next, the case of performing three-dimensional display will be described with reference to FIG. 13. FIG. 13 is a schematic view illustrating the image display device 100 in the case of performing the three-dimensional display to view points at different positions.

In the image display device 100 shown in FIG. 13, as for the view points 11s1 and 11s2 at different viewing positions, the image data 1 is displayed to the view point 11s1 and the image data 2 is displayed to the view point 11s2. Each of the image data 1 and the image data 2 is the image data constituting a three-dimensional image, and is composed of sub-pixel data of the image displayed to a left eye (left eye sub-pixel data) and sub-pixel data of the image displayed to a right eye (right eye sub-pixel data).

In the liquid crystal panel 20 of FIG. 10, “a” represents left eye sub-pixel data displayed to the left eye and “b” represents right eye sub-pixel data displayed to the right eye. For example, R1a represents the left eye sub-pixel data of the image data 1.

In the case of displaying the image data 1 which is a three-dimensional image to the view point 11s1 and the image data 2 which is a three-dimensional image to the view point 11s2, the control portion 40 divides the sub-pixels SG1 to SG8 in the unit display region into four groups, and alternately places the right eye sub-pixel data and the right eye sub-pixel data of each image on the divided groups. For example, in the example of FIG. 13, in the unit display region, the control portion 40 places the left eye sub-pixel data R1a and G1a of the image data 1 on the sub-pixels SG1 and SG2, and right eye sub-pixel data B1b and R1b of the image data 1 on the sub-pixels SG3 and SG4. Further, the control portion 40 places the sub-pixel data G2a and B2a of the left eye pixel data of the image data 2 on the sub-pixels SG5 and SG6 and the right eye sub-pixel data R2b and G2b of the image data 2 on the sub-pixels SG7 and SG8. Here, the position of the view point 11s1 is a position at which the light beams from the sub-pixels SG1 and SG2 enter the left eye of a viewer and the light beams from the sub-pixels SG3 and SG4 enter the right eye of the viewer. The position of the view point 11s2 is a position at which the light beams from the sub-pixels SG5 and SG6 enter the left eye of a viewer and the light beams from the sub-pixels SG7 and SG8 enter the right eye of the viewer.

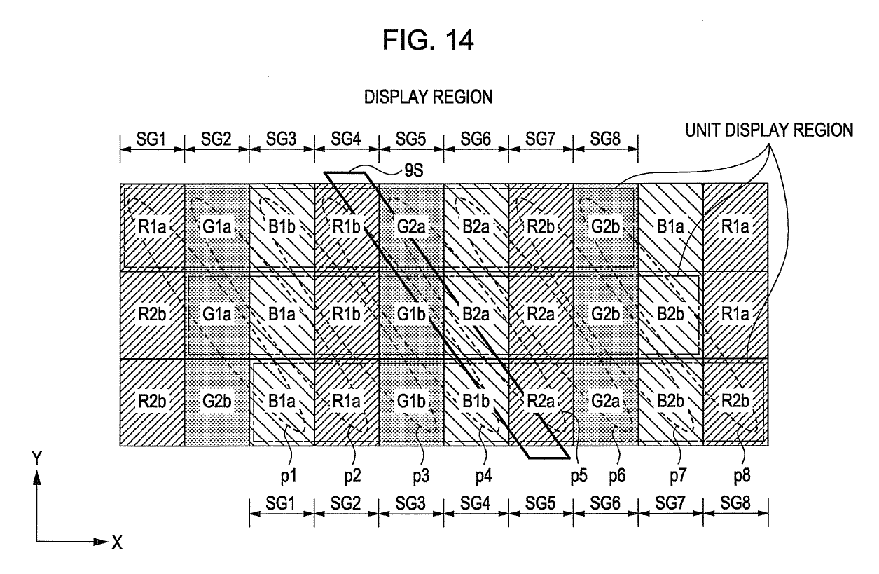

FIG. 14 is a plan view illustrating the liquid crystal panel 20 of the image display device 100 in the case of performing the three-dimensional display.

As shown in FIG. 14, in the case of performing the three-dimensional display, in the region corresponding to the unit display region on the first row of the display region, the sub-pixel data are placed in the order of R1a, G1a, B1b, R1b, G2a, B2a, R2b, and G2b. In the region corresponding to the unit display region on the second row of the display region, the sub-pixel data are placed in the order of G1a, B1a, R1b, G1b, B2a, R2a, G2b, and B2b. In the region corresponding to the unit display region on the third row of the display region, the sub-pixel data are placed in the order of B1a, R1a, G1b, B1b, R2a, G2a, B2b, and R2b. Accordingly, when considering the display region in the range from the first to third rows, as shown in FIG. 14, since both of the pixels p1 and p2 are left eye pixels of the image data 1, they belong to the same group. Further, since both of the pixels p3 and p4 are pixels for right eye pixels of the image data 1, they also belong to the same group. Still further, since both of the pixels p5 and p6 are left eye pixels of the image data 2, they belong to the same group. Since the pixels p7 and p8 are right eye pixels of the image data 2, they belong to the same group.

With this structure, at the view point 11s1, the left eye of the viewer can see the left eye pixel data of the image data 1 through the slit 9S and the right eye of the viewer can see the right eye pixel data of the image 1 through the slit 9S. Accordingly, the light beams from the pixels to which the left eye image and the right eye image of the image data 1 are displayed gather passing through the plurality of slits 9S. For such a reason, the image data 1 is recognized as the three-dimensional image by the viewer at the view point 11s1. Further, at the view point 11s2, since the left eye of the viewer can see the left eye sub-pixel data of the image data 2 through the slit 9S and the right eye of the viewer can see the right eye sub-pixel data of the image data 2 through the slit 9S, the light beams from the pixels to which the left eye image and the right eye image of the image data 2 are displayed gather passing through the plurality of slits 9S. Accordingly, the image data 2 can be recognized as a three-dimensional image by the viewer at the view point 11s2.

That is, it is possible to display the three-dimensional image to the view point by alternately placing the left eye pixel and the right eye pixel on the plurality of pixels in the plurality of unit display regions adjacent to each other group by group.

As can be seen from the above, according to the image display device 100 of the embodiment, the control portion 40 can change the display mode, such that the number of view points of the image display can be changed or the device can be switched between the multi-picture display and the three-dimensional display without modification of the structure thereof by controlling the pixel data displayed to the pixels in the display region. That is, according to the image display device 100 of the embodiment, it is possible to change the viewing angle of each of the display images with high precision without modification of the structure of the image display device. The image display device 100 of the embodiment sets the number of sub-pixels in the unit display region, i.e. the maximum viewpoint, to 8, but the number of sub-pixels in the unit display region is not limited to 8. It is not doubtful that the invention can be applied to any image display device as long as the image display device is structured such that there is a plurality of sub-pixels in a unit display region.

### Modification

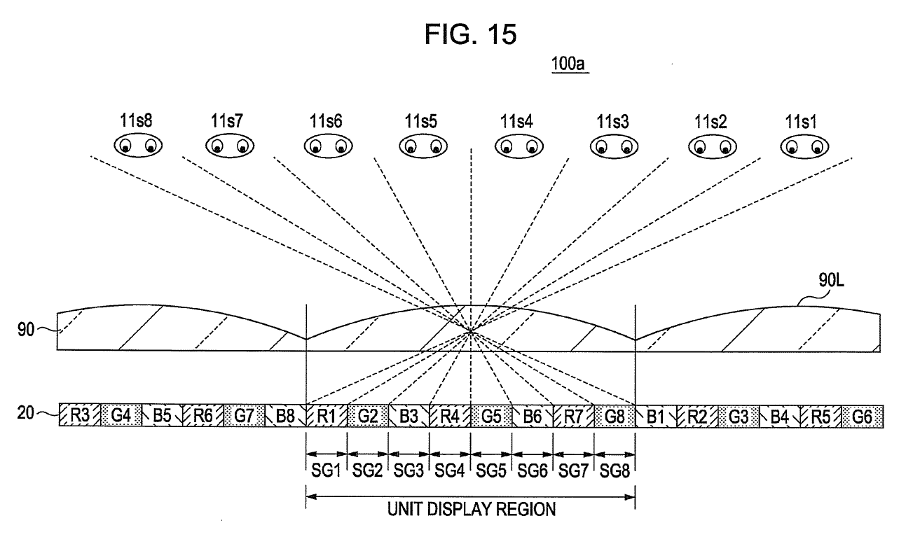

Next, one modification of the image display device 100 according to the embodiment will be described. FIG. 15 is a schematic view illustrating an image display device 10a according to one modification.

In the image display device 100 described above, the light separating element which separates the light emitted from the sub-pixels SG1 to SG8 of the liquid crystal panel 20 into light beams directing in different directions uses the parallax barrier 9. However, the image display device to which the invention can be applied is not limited thereto. In the image display device 100a shown in FIG. 15, the light separating element uses a lenticular lens 90 having a plurality of lens patterns 90L in a line form instead of the parallax barrier 9. As shown in FIG. 15, each of the lens patterns 90L is formed in the lenticular lens 90 such that its sectional form is, for example, semi-cylindrical in shape and its width is almost equal to the size of the unit display region. Further, the lenticular lens 90 is placed, with respect to the liquid crystal panel 20, such that the position at which the thickness of the lens pattern 90L is at its maximum is at the center of the unit display region, i.e. an intermediate portion between the sub-pixels SG4 and SG5. The lenticular lens 90 is structured such that the pixel data displayed to the sub-pixels SG1 to SG8 are focused on the corresponding view point. That is, the lenticular lens 90 has a shape in which the distance between each of the view points 11s1 to 11s8 and the lens becomes the focal length in the direction.

With such a form, the light beams emitted from the sub-pixels SG1 to SG8 are refracted in the lens patterns 90L and reach the view points 11s1 to 11s8 which are focal positions. Since the lenticular lens 90 is provided with the lens patterns 90L, as the light from the pixels to the image data are displayed gathers via the plurality of lens patterns 90L, the images to be displayed are displayed to the view points 11s1 to 11s8, respectively.

The device structure shown in FIG. 15 is the same as in the case of a multi-picture display, such as the eight-picture display, the two-picture display, the three-picture display, and also the three-dimensional display. That is, the image display device 100a, having the lenticular lens 90 according to the modification, can also change the display mode without modifying the device, like the image display device 100 using the parallax barrier 9. That is, the same effects as described in the above embodiment can also be achieved when the image display device 100a according to the modification is used.

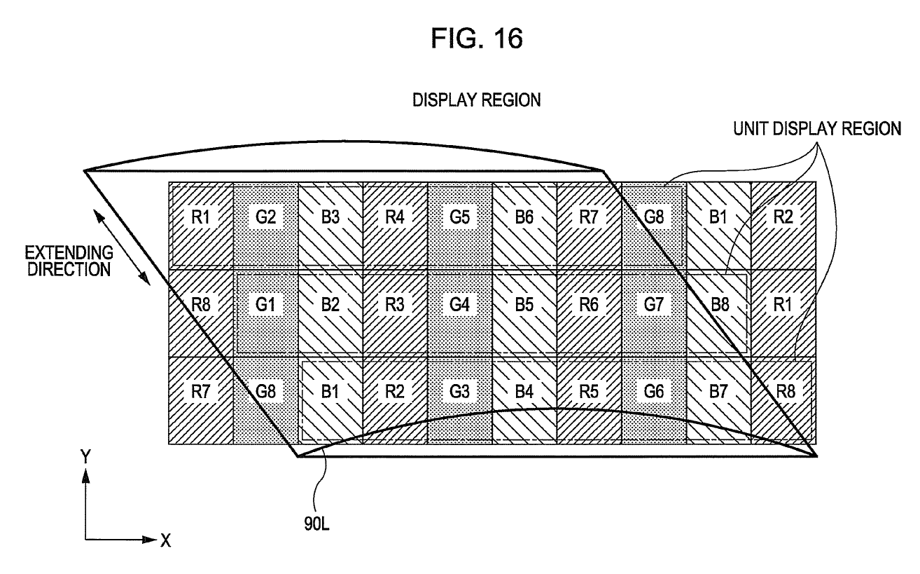

FIG. 16 is a schematic view illustrating the lens pattern 90L. As shown in FIG. 16, in the image display device 100a, like the slit of the parallax barrier described above, the lens patterns 90L are formed in the lenticular lens 90 such that the extension direction of the lens pattern 90L is diagonal to the Y direction, i.e. the arrangement direction of the plurality of sub-pixels constituting the unit display region by the amount of the misalignment between the sub-pixels SG4 and SG5 (the amount of misalignment of the unit display region), i.e. the amount of one sub-pixel, and is diagonal to the X-direction. In this manner, it is possible to enhance the brightness of the display image because light is not blocked when the lenticular lens 90 is used, as compared to when the parallax barrier is used.

### Electronic Apparatus

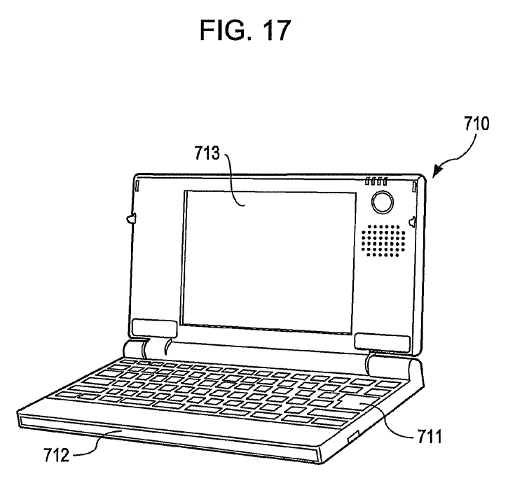

Next, electronic apparatuses to which the image display devices 100 and 100a according to the above embodiments can be applied will be exemplified with reference to FIG. 17.

A first example is a portable personal computer (so-called notebook computer) in which the image display devices 100 and 100a according to the embodiment are applied to a display unit. FIG. 17 perspectively shows the structure of the portable personal computer. As shown in FIG. 17, the portable personal computer 710 includes a body unit 712 including a keyboard 711 and a display unit 713 to which the liquid crystal device 100 according to the invention is applied.

It is preferable that the image display devices 100 and 100a according to each of the embodiments are applied to a display unit of a liquid crystal television set or a car navigation device. For example, when the image display device 100 and 100a according to the embodiment are applied to the display unit of the car navigation device, it is possible to provide a map to a viewer on a driver's seat and a movie to a viewer on a passenger's seat by the car navigation device.

Other examples of an electronic apparatus to which the image display device 100 and 100a according to each of the embodiments can be applied include a viewfinder type or monitor type video recorder, a pager, an electronic organizer, a calculator, a cellular phone, a word processor, a workstation, a video conferencing phone, a POS terminal, a digital still camera, or the like.

The entire disclosure of Japanese Patent Application No. 2008-181840, filed Jul. 11, 2008 is expressly incorporated by reference herein.

What is claimed is:

1. An image display device displaying a plurality of images visible in different directions, comprising:
a plurality of unit display regions, each having a plurality of sub-pixels arranged therein;
a plurality of pixel groups, each including a plurality of pixels, each pixel being composed of the sub-pixels included in the unit display regions adjacent to each other;
a separating element which separates light of the image into light beams directed in different directions in the unit of one pixel group;
an image signal supply unit which supplies an identical image signal or different image signals to the plurality of pixel groups, respectively; and
a selection unit which selects a number of pixel groups or a number of pixels included in the pixel group.

2. The image display device according to claim 1, wherein the pixel is composed of a plurality of sub-pixels displaying different colors.

3. The image display device according to claim 1, wherein the selection unit differently set the numbers of pixels included in the pixel groups.

4. The image display device according to claim 1, wherein the image signal supply unit alternately supplies a right eye signal and a left eye signal of the image signals to the plurality of pixel groups.

5. The image display device according to claim 1, wherein the unit display regions adjacent to each other in a perpendicular direction to an arrangement direction in which the plurality of sub-pixels is arranged are arranged such that they are misaligned with each other in the arrangement direction.

6. The image display device according to claim 5, wherein the separating element is a parallax barrier with a plurality of slits, in which the plurality of slits are formed in the parallax barrier such that they extend obliquely to the perpendicular direction of the arrangement direction of the sub-pixels by an amount of misalignment.

7. The image display device according to claim 5, wherein the separating element is a lenticular lens with a plurality of lens patterns, in which the lens patterns are formed in the lenticular lens such that they extend obliquely to the perpendicular direction of the arrangement direction of the sub-pixels are arranged by an amount of misalignment.

8. An electronic apparatus comprising the image display device according to claim 1 as a display portion.

9. An image display method of displaying a plurality of images to a plurality of unit display regions adjacent to each other such that the plurality of images are visible in different directions by separating light from a plurality of pixels into light beams directing in different directions when there are unit display regions, each having a plurality of sub-pixels arranged therein, and the plurality of pixels is arranged in the adjacent unit display regions, comprising:
supplying an identical image signal to the pixels belonging to one pixel group or different image signals to the pixels belonging to different pixel groups, respectively while making the plurality of pixels belong to one or a plurality of pixel groups; and
selecting the number of pixel groups or the number of pixels included in each pixel group.

10. An image display program executed in a control portion which controls an image display device in which there are unit display regions, each having a plurality of sub-pixels arranged therein, a plurality of pixels is arranged in plural unit display regions adjacent to each other, and a plurality of images displayed at the plurality of unit display regions adjacent to each other is visible in different directions by separating light from the plurality of pixels into light beams directing in different directions, wherein the image display program causes the control portion to function as:
an image signal supply unit which makes the plurality of pixels belong to one pixel group or a plurality of pixel groups and supplies an identical image signal to the pixels belonging to one pixel group and different image signals to the pixels belonging to different pixel groups; and
a selection unit which selects the number of pixel groups or the number of pixels included in each pixel group.
